(19) United States
(12) Patent Application Publication
(10) Pub. No.: US 2023/0123381 A1
(43) Pub. Date: Apr. 20, 2023

(54) COMPOSITIONS

(71) Applicant: Mexichem Fluor S.A. de C.V., San Luis Potosi (MX)

(72) Inventor: Robert E. Low, Runcorn (GB)

(21) Appl. No.: 17/795,417

(22) PCT Filed: Feb. 12, 2021
(86) PCT No.: PCT/GB2021/050347

§ 371 Date: Jul. 26, 2022

(30) Foreign Application Priority Data
Feb. 14, 2020 (GB) 2002063.2

(51) Int. Cl. C09K 5/04; F25B 9/00

(52) U.S. Cl. CPC C09K 5/045; F25B 9/006; C09K 2205/106; C09K 2205/126

(57) ABSTRACT

The invention provides a composition comprising (a) carbon dioxide (R-744, C0₂); (b) difluoromethane (R-32); and (c)a third component selected from 1,1,1,2-tetrafluoroethane (R- 134a), trans- 1,3, 3, 3-tetrafluoropropene (R-1234ze(E)), 2,3,3,3-tetrafluoropropene (R-1234yf), 1,1,1,2,3,3,3-heptafluoropropane (R-227ea) and mixtures thereof.

The present invention relates to compositions suitable for use as working fluids in air-conditioning and refrigeration applications. The compositions disclosed herein are especially useful in heat pump water heaters, air-conditioning systems for trains, buses, cars and trucks, commercial refrigeration systems including supermarket display systems and cold rooms (such as walk-in fridges and freezers), and transportation refrigeration systems.

The listing or discussion of a prior-published document or any background in the specification should not necessarily be construed as an acknowledgement that a document or background is part of the state of the art or is common general knowledge.

Carbon dioxide (CO₂, R-744) is finding favour as a low Global Warming Potential (GWP) refrigerant for applications where non-flammability of refrigerant is required. These applications include air-conditioning systems for trains, buses, cars and trucks; heat pump-water heater systems; commercial refrigeration systems including supermarket display systems and cold-rooms, and transportation refrigeration systems fitted to refrigerated shipping containers or trucks.

CO₂ has two main disadvantages compared to other fluorocarbon refrigerants in use in the same applications. Firstly, it suffers from low energy efficiency in ambient temperatures of above about 25 to 30° C. Secondly, its operating pressures are much higher than those of traditional fluorocarbon-based systems.

Non-flammable refrigerant mixtures comprising difluoromethane (R-32) and CO₂ have been proposed (see Adams et al. (J. Chem. Eng. Data 16 (1971) 146-149) and US 7238299B, the contents of which are incorporated herein by reference in their entirety). Such non-flammable compositions can contain up to about 60% R-32 by weight.

However, such binary refrigerant compositions, whilst non-flammable as formulated, would still be considered as flammable according to ASHRAE Standard 34 (2019). This is because the mixtures are non-azeotropic. ASHRAE Standard 34 requires that the outcome of a series of vapour leakage experiments at a range of temperatures from -40° C. to 60° C. is considered to identify whether leakage can generate a more flammable composition than the “as-formulated” composition. When this is done for non-flammable binary mixtures of R-32 with CO₂, a vapour leakage at -40° C. will result in generation of a flammable composition, as the more volatile CO₂ is preferentially removed from the system, causing fractionation of the remaining material so that it contains more than 60% R-32.

Therefore, it would be desirable to identify refrigerant compositions which address these problems, whilst preferably retaining the non-flammability of pure CO₂. Such compositions should preferably also have a low GWP. In particular, a GWP of about 150 or less would be required under the European Union F-Gas Regulations for certain applications, such as air-conditioning systems in passenger cars or self-contained refrigeration appliances.

The present invention addresses the above and other deficiencies, and the above needs, by the provision of a composition comprising carbon dioxide (CO₂, R-744), difluoromethane (R-32), and a third component selected from 1,1,1,2-tetrafluoroethane (R-134a), trans-1,3,3,3-tetrafluoropropene (R-1234ze(E)), 2,3,3,3-tetrafluoropropene (R-1234yf), 1,1,1,2,3,3,3-heptafluoropropane (R-227ea) and mixtures thereof.

Such compositions will be referred to hereinafter as “the compositions of the (present) invention”.

The present inventor has found that relatively minor amounts of other components (especially R-134a) may be added to CO₂ and R-32 to ensure that the resulting mixture will not fractionate to a flammable composition when analysed according to the ASHRAE Standard 34 protocol. Furthermore, minor amounts of a flammable species (e.g. R-1132a) may also be added to the mixtures of the present invention without generating a flammable composition.

The compositions of the present invention are believed to be especially useful in heat transfer systems (e.g. refrigeration, air-conditioning and heat pump systems) utilising a transcritical refrigeration cycle. The basic transcritical cycle consists of the following steps:
(a) Evaporation of a liquid refrigerant at low pressure to remove heat from a low temperature source fluid (such as air);
(b) Compression of the resultant refrigerant vapour in a compressor to yield a hot, high pressure gas;
(c) Cooling of the high-pressure gas by heat exchange with a sink fluid, at higher temperature than the source, to yield a cooler, dense refrigerant gas at high pressure. This gas is said to be a “supercritical” fluid, since it is above its critical temperature; and
(d) Expansion of the supercritical fluid through an expansion valve or other restriction device to give a two-phase mixture of liquid refrigerant with vaporised refrigerant vapour at low pressure; this mixture is then fed back to the evaporator stage (a) to complete the cycle.

Optionally, in such a cycle there occurs an internal heat exchange process between the warm high-pressure gas leaving the gas cooler, and the cool vapour flowing from the evaporator to the compressor. This process takes place in an “internal heat exchanger” (“IHX”) and has the effect of boosting the refrigeration capacity and efficiency of the cycle.

Conveniently, such a transcritical refrigeration cycle may also contain a liquid accumulator positioned after the evaporator (and before the IHX, if one is used). This serves to hold excess charge of refrigerant when the external ambient temperature is such that the gas cooler pressure is reduced.

The compositions of the present invention have also been found to be suitable for use in such cycles, whether incorporating IHX or accumulator features or not.

The compositions of the present invention will now be described in detail.

According to the present invention, there is provided a composition comprising CO₂, R-32 and a third component selected from 1,1,1,2-tetrafluoroethane (R-134a), trans-1,3,3,3-tetrafluoropropene (R-1234ze(E)), 2,3,3,3-tetrafluoropropene (R-1234yf), 1,1,1,2,3,3,3-heptafluoropropane (R-227ea) and mixtures thereof.

In one aspect of the present invention, the third component is R-134a and one or more of R-1234yf, R-1234ze(E) and R-227ea.

In another aspect of the present invention, the third component is R-134a, provided that the composition does not comprise 86 weight % CO₂ ±1 weight %, 7 weight % R-32 ±1 weight % and 7 weight % R-134a ±1 weight %.

In a further aspect of the present invention, the third component is one or more of R-1234yf or R-1234ze(E).

In yet another aspect of the present invention, the third component is one or more of R-1234yf, R-1234ze(E) and R-227ea.

Typically, the compositions of the present invention comprise from about 62 or about 65 to about 98 weight % CO₂, such as from about 69 or about 71 to about 97 weight %, for example from about 74 or about 77 to about 96 weight % or from about 81 to about 96 weight %, optionally from about 81 or about 84 to about 95 weight %.

Typically, the compositions of the present invention comprise from about 1 to about 25 weight % R-32, such as from about 2 to about 22 weight %, for example from about 3 to about 19 weight %, optionally from about 4 weight % to about 15 or about 13 weight % or from about 5 weight % to about 11 weight %

Conveniently, the compositions of the invention comprise from about 1 to about 20 weight % of the third component, such as from about 2 or about 3 to about 15 weight %, for example from about 4 to about 13 weight %, optionally from about 5 to about 11 weight %.

In one embodiment, the compositions of the invention comprise, optionally consist essentially of, from about 65 to about 95 weight % CO₂, from about 5 to about 15 weight % R-32 and from about 2 to about 20 weight % R-134a.

In such compositions, preferably the CO₂ is present in amount of from about 70 to about 91 weight %, the R-32 is present in an amount of from about 6 to about 14 weight % and the R-134a is present in an amount of from about 3 to about 16 weight %. For instance, in such compositions the CO₂ is present in amount of from about 72 to about 88 weight %, the R-32 is present in an amount of from about 8 to about 13 weight % and the R-134a is present in an amount of from about 4 to about 15 weight %.

The compositions of the present invention may additionally comprise 1,1-difluoroethylene (R-1132a).

When present, the compositions of the invention comprise from about 1 to about 20 weight % R-1132a, such as from about 2 to about 15 weight %, for example from about 3 to about 12 weight % or from about 4 or about 5 to about 10 weight %.

The compositions of the invention typically do not contain 1,1,2-trifluoroethylene (R-1123). Various refrigerant compositions comprising R-1123 are known in the art. Although one advantage of using R-1123 in such compositions is that it gives similar capacity to R-32, at the same time having negligible GWP, it may only be safely used as a diluted component in many refrigerant compositions. It is believed that the inclusion of R-1123 in the compositions of the present invention can cause problems with stability of the compositions and therefore lead to safety concerns regarding the use of such compositions.

Furthermore, in the course of development, the present inventors have found that while the inclusion of R-1123 in the compositions of the invention gives similar capacity as compared to using an equivalent molar quantity of R-32, it reduces the energy efficiency of the compositions. When considering the overall environmental impact of a system using these compositions (which is a combination of the effect of leakage of the refrigerant (“direct emission” of greenhouse gas) and the energy efficiency of the refrigerant leading to CO₂ emissions from fuel or energy usage (“indirect emissions” of greenhouse gas)), the marginal reduction in GWP available from use of R-1123 is more than offset by the reduction in energy efficiency. Accordingly, R-1123 is preferably not included in the compositions of the invention.

Accordingly, in one embodiment, the compositions of the invention are substantially free of R-1123. For example, the compositions of the invention contain no readily detectable R-1123. In a preferred embodiment, such compositions contain no R-1123.

In one aspect, the compositions of the invention do not contain 80 weight % CO₂. For example, when the composition of the invention contains from 1 to 15 weight % R-32, from 1 to 15 weight % R-227ea and from 5 to 75 weight % of either R-1234yf or R-1234ze (for example, trans-R-1234ze), the composition does not contain 80 weight % CO₂. Preferably, such compositions contain greater than 80 weight % CO₂, such as greater than 81 or 82 weight % CO₂.

In one embodiment, the compositions of the present invention consist essentially of the stated components. By the term “consist essentially of”, we include the meaning that the compositions of the invention contain substantially no other components, particularly no further (hydro)(fluoro)compounds (e.g. (hydro)(fluoro)alkanes or (hydro)(fluoro)alkenes)) known to be used in heat transfer compositions. The term “consist of” is included within the meaning of “consist essentially of”.

In one embodiment, the compositions of the invention are substantially free of any component that has heat transfer properties (other than the components specified). For instance, the compositions of the invention may be substantially free of any other hydrofluorocarbon compound.

By “substantially no” and “substantially free of” we include the meaning that the compositions of the invention contain 0.5% by weight or less of the stated component, preferably 0.4%, 0.3%, 0.2%, 0.1% or less, based on the total weight of the compositions.

As used herein, all % amounts mentioned in the compositions herein, including in the claims, are by weight based on the total weight of the composition, unless otherwise stated.

By the term “about”, as used in connection with numerical values of amounts of component in % by weight, we include the meaning of ± 0.5 weight %, for example ± 0.2 weight %.

For the avoidance of doubt, it is to be understood that the stated upper and lower values for ranges of amount of components in the compositions of the invention described herein may be interchanged in any way, provided that the resulting ranges fall within the broadest scope of the invention.

The compositions of the present invention have zero ozone depletion potential.

Typically, the compositions of the invention have a Global Warming Potential (GWP) of less than about 300, such as less than about 240, such as less than about 200, for example less than about 160 or less than about 150, preferably less than about 145.

Conveniently, the compositions of the invention are of reduced flammability hazard when compared to R-1132a.

Flammability may be determined in accordance with ASHRAE Standard 34 (e.g. ASHRAE Standard 34:2019), the entire content of which is incorporated herein by reference.

In one aspect, the compositions have one or more of (a) a higher lower flammable limit; (b) a higher ignition energy (c) a higher auto-ignition temperature; or (d) a lower burning velocity compared to R-1132a alone.

Preferably, the compositions of the invention are less flammable compared to R-1132a in one or more of the following respects: lower flammable limit at 23° C.; lower flammable limit at 60° C.; breadth of flammable range at 23° C. or 60° C.; auto-ignition temperature (thermal decomposition temperature); minimum ignition energy in dry air or burning velocity. The flammable limits and burning velocity being determined according to the methods specified in ASHRAE-34 and the auto-ignition temperature being determined in a 500 ml glass flask by the method of ASTM E659-78.

In a preferred embodiment, the compositions of the invention are non-flammable both as formulated and under the fractionation scenarios of ASHRAE Standard 34:2019. For example, the compositions of the invention and preferably their “worst case formulations for flammability” are both non-flammable at a test temperature of 60° C. using the ASHRAE-34 methodology. Advantageously, the mixtures of vapour that exist in equilibrium with the compositions of the invention at any temperature between about -20° C. and 60° C. are also non-flammable.

In some applications it may not be necessary for the formulation to be classed as non-flammable by the ASHRAE-34 methodology. It is possible to develop fluids whose flammability limits will be sufficiently reduced in air to render them safe for use in the application, for example if it is physically not possible to make a flammable mixture by leaking the refrigeration equipment charge into the surrounds. A preferred example of such a scenario is where the composition is formulated to be non-flammable but where application of the Standard 34 fractionation methodology would result in generation of a flammable “worst-case formulation for flammability”; where however the scenario is not considered relevant for the application. Similarly, preferred compositions are those which would be classed as non-flammable as formulated but weakly flammable under fractionation (flammability class 1/2L) by the ISO 817 classification standard.

It is believed that the compositions of the invention exhibit a completely unexpected combination of low/non-flammability, low GWP, improved lubricant miscibility and improved performance properties when used in refrigeration systems, especially in air-conditioning systems. Some of these properties are explained in more detail below.

Typically, the compositions of the present invention have a critical temperature which is about equal to or higher than the critical temperature of CO₂, for example higher than about 40° C.

Conveniently, the compositions of the present invention have a volumetric refrigeration capacity that is within at least about 75% of that of CO₂, such as within at least about 80%, for example within at least about 90%.

Advantageously, the compositions of the present invention have a coefficient of performance (COP) that is about equal to or higher than that of CO₂.

Typically, the compositions of the present invention have an operating pressure in a gas cooler and evaporator that is lower than that of CO₂. The reduction in operating pressures can result in benefits for compressor efficiency and durability, for example by reducing the absolute pressure difference over the compressor, which reduces the load on the machine bearings. Furthermore, this reduced pressure difference can benefit the volumetric efficiency of the compressor.

Conveniently, the compositions of the present invention have a temperature glide (defined as the difference between dew point and inlet temperature) in an evaporator which is less than about 12 K, such as less than about 10 K, for example less than about 8 K, preferably less than about 6 K.

The compositions of the invention are typically suitable for use in existing designs of equipment and are compatible with all classes of lubricants that are currently used with established HFC refrigerants and with R-744. They may be optionally stabilized or compatibilized with mineral oils by the use of appropriate additives.

Preferably, the lubricant is selected from mineral oil, silicon oil, polyalkyl benzenes (PABs), polyol esters (POEs), polyalkylene glycols (PAGs), polyalkylene glycol esters (PAG esters), polyvinyl ethers (PVEs), poly (alpha-olefins) and combinations thereof, preferably wherein the lubricant is selected from PAGs, POEs, PVEs and combinations thereof.

Compositions comprising a lubricant and a composition of the invention typically exhibit improved miscibility compared to CO₂ and the same lubricant.

Conveniently, a stabiliser is selected from diene-based compounds, phosphates, phenol compounds and epoxides, and mixtures thereof.

In another aspect of the present invention, there is provided a use of a composition of the present invention as a working fluid in a heat transfer system.

Typically, the heat transfer system is a refrigeration, heat pump or air-conditioning system.

Preferably, the refrigeration system comprises a commercial refrigeration system (such as a supermarket display refrigeration system, beverage cooler refrigeration system, warehouse refrigeration system or a cold-room refrigeration system), or a transportation refrigeration system (for example a refrigeration system fitted to a refrigerating shipping container or a refrigeration system fitted to a vehicle).

Conveniently, the heat pump system comprises a water heater heat pump system.

Preferably, the air-conditioning system comprises a mobile or transportation air-conditioning system, such as a bus, car, train or truck air-conditioning system.

Advantageously, the heat transfer (e.g. refrigeration, heat pump and/or air-conditioning) systems defined above are operating as transcritical heat transfer systems for at least part of the year.

In some of the applications of transcritical cycle technology, a vapour compression cycle used is a single compression cycle as is typical in mobile air-conditioning applications. In other applications, the gas compression is carried out in two stages, which permits efficient operation over a large temperature difference between heat source and heat sink temperatures. It is believed that the compositions of the invention are suitable for use in a single and dual compression stage cycle.

In one aspect of the present invention, there is provided a use of the composition of the invention as an alternative for an existing working fluid in a heat transfer device, such as a new heat transfer device designed to meet the same application requirements

Conveniently, the existing working fluid is R-410A or R-407C.

In another aspect of the present invention, there is provided a heat transfer device comprising a composition of the present invention.

Preferably, the heat transfer device is a transcritical heat transfer device, such as a transritical refrigeration, heat pump or air-conditioning device.

Optionally, the transcritical heat transfer device comprises an internal heat exchanger (IHX) system.

The transcritical heat transfer device may also comprise a liquid accumulator positioned after the evaporator, or, if the IHX is present, between the evaporator and the IHX.

According to another aspect of the invention, there is provided a method of producing heating which comprises condensing or cooling a composition of the invention in the vicinity of a body to be heated.

According to another aspect of the invention, there is provided a method of producing cooling which comprises evaporating a composition of the invention in the vicinity of a body to be cooled.

All the chemicals described herein are commercially available. For example, fluorochemicals may be purchased from Apollo Scientific (UK).

The compositions of the invention may be prepared by simply mixing CO₂, R-32 and the third component (and optional components, such as R-1132a and/or a lubricant) in the desired proportions. The compositions can then be added to a heat transfer device or used in any other way as described herein.

The present invention is illustrated by the following non-limiting examples.

### EXAMPLES

The vapour liquid equilibrium behaviour of CO₂ with R-32 and with R-134a at certain temperatures is described in the academic literature.. The vapour liquid equilibrium behaviour of CO₂ with R134a, and of R-1132a with CO₂ ,R-32 and R-134a was studied experimentally in the temperature range -40° C. to +70° C. using constant-volume equilibrium apparatus. The resulting data were used to fit binary interaction parameters for each binary pair for use with the NIST REFPROP9.1 and REFLEAK5.1 software codes. The principle of measurement of this experimental work was the determination of vapour pressure for a series of known compositions over a range of temperatures, followed by regression to the thermodynamic model to minimise the difference between calculated and observed pressure over the data set.

Subsequently, a series of ternary compositions of CO₂/R-32/R-134a were subjected to a fractionation assessment following the general outline given in ASHRAE Standard 34 and using the REFPROP property library to model the refrigerant behaviour. The “worst case scenario” was taken as the leakage of vapour isothermally at -40° C. from a cylinder initially charged with 90% of the maximum allowable fill quantity of material. The leakage was modelled to simulate a loss of 95% of the initial mass. The maximum allowable fill was determined using the liquid density calculated at the temperature specified in the standard for modelling fluids with a critical temperature below 54.4° C.

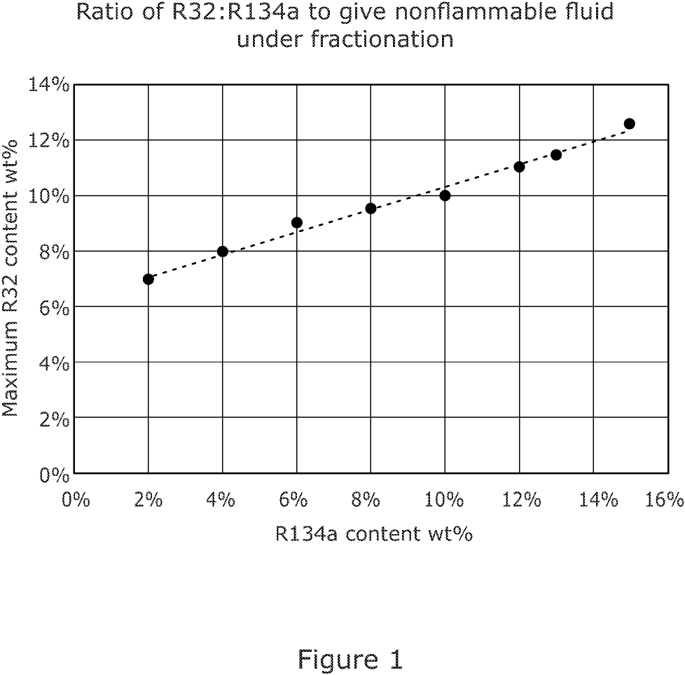

FIG. 1 shows the maximum content of R-32 that could be included in a composition without the fractionation generating a flammable composition as a function of the content of R-134a (from 0 to 15 weight %).

Standard refrigeration cycle modelling techniques were then used to estimate the performance of selected compositions of the invention in the range of from about 4 to about 14 weight % of R-134a. The R-32 content was selected according to FIG. 1 to give a composition that would remain non-flammable under fractionation.

The cycle modelled was a transcritical cycle using an internal heat exchanger (IHX) to exchange heat between the gas leaving the gas cooler and the low-pressure vapour leaving the evaporator.

The performance of CO₂ was also calculated as a comparative example. The cycle conditions were chosen to ensure that CO₂ was operating as a transcritical refrigerant in the cycle. The gas cooler pressure in the cycle was optimised to maximise Coefficient of Performance (COP) of the mixture.

The following conditions were assumed for the modelling purposes:

TABLE 1

Model input conditions

| | | |
|---|---|---|
| Air temperature rise over gas cooler | 10 | K |
| Air on temperature | 33 | °C |
| Air off temperature | 43 | °C |
| Temperature approach in gas cooler | 4 | K |
| Capacity | 6 | kW |
| Mean evaporation temperature | 7 | °C |
| Evaporator superheat | 0 | K |
| Suction line heat gain across IHX | 20 | K |
| isentropic efficiency | 65% | |

The results are shown in Table 2 below.

From the performance data, it can be seen that the ternary compositions modelled have superior energy efficiency and reduced operating pressures compared to CO₂. In addition, the GWP of the compositions is less than about 300.

Furthermore, it can be seen that it is not desirable to add more than about 15% R-134a by weight in these compositions because the temperature glide in the evaporator becomes greater than 11 K.

The ternary compositions of the invention may be further augmented by the addition of R-1132a, for example by substitution of a portion of the CO₂ content with R-1132a so that the R-1132a content is between 1% and 15% by weight without generating a flammable composition during fractionation. Addition of R-1132a reduces compressor discharge temperature and reduces the temperature glide in the evaporator. The modelling results for a selected composition comprising R-1132a are shown in Table 3 below.

TABLE 2

Compositions comprising CO₂, R-32 and R-134a.

| | | | | | | | | | |
|---|---|---|---|---|---|---|---|---|---|
| | R744 | 100.0% | 88.0% | 85.0% | 83.0% | 80.0% | 77.0% | 74.0% | 72.5% |
| | R32 | 0.0% | 8.0% | 9.0% | 9.0% | 10.0% | 11.0% | 12.0% | 12.5% |
| | R134a | 0.0% | 4.0% | 6.0% | 8.0% | 10.0% | 12.0% | 14.0% | 15.0% |
| Coefficient of performance (COP) | | 2.69 | 2.84 | 2.88 | 2.90 | 2.95 | 2.98 | 3.01 | 3.02 |
| Volumetric refrigeration capacity (Qᵥₒₗ) | kJ/m³ | 14497 | 13220 | 12860 | 12593 | 12404 | 12277 | 12106 | 12022 |
| Compressor discharge temperature (T_{dis}) | °C | 102.6 | 105.6 | 106.2 | 106.7 | 108.0 | 110.1 | 112.0 | 112.9 |
| Evaporator pressure (Pₑᵥ) | bar | 41.8 | 35.5 | 33.9 | 32.9 | 31.4 | 30.0 | 28.7 | 28.1 |
| Condenser pressure (P_{co}) | bar | 90.2 | 77.8 | 74.8 | 72.7 | 70.4 | 68.6 | 66.9 | 66.0 |
| Evaporator temperature glide ΔTₑᵥ | K | 0.0 | 4.4 | 5.7 | 6.8 | 8.3 | 9.7 | 11.1 | 11.8 |
| COP relative to R-744 | | 100.0% | 105.8% | 107.3% | 108.0% | 109.8% | 110.9% | 111.9% | 112.5% |
| Capacity relative to R-744 | | 100.0% | 91.2% | 88.7% | 86.9% | 85.6% | 84.7% | 83.5% | 82.9% |
| Global Warming Potential (AR5 basis) | | 1 | 107 | 140 | 166 | 199 | 231 | 264 | 280 |

TABLE 3

A composition comprising CO₂, R-32, R-134a and R-1132a

| | | |
|---|---|---|
| R744 | | 65% |
| R1132a | | 15% |
| R32 | | 10% |
| R134a | | 10% |
| COP | | 2.85 |
| Qvol | kJ/m³ | 11531 |
| Tdis | °C | 103.7 |
| Pev | bar | 30.5 |
| Pco | bar | 68.3 |
| DTev | K | 7.8 |
| COP relative to CO2 | | 106.1% |
| Capacity relative to CO2 | | 79.5% |
| GWP (AR5 basis) | | 198 |

1. A composition comprising:
(a) carbon dioxide (R-744, CO₂);
(b) difluoromethane (R-32); and
(c) a third component selected from 1,1,1,2-tetrafluoroethane (R-134a), trans-1,3,3,3-tetrafluoropropene (R-1234ze(E)), 2,3,3,3-tetrafluoropropene (R-1234yf), 1,1,1,2,3,3,3-heptafluoropropane (R-227ea) and mixtures thereof.

2. The composition according to claim 1, wherein the third component is R-134a and one or more of R-1234yf, R-1234ze(E) and R-227ea.

3. The composition according to claim 1, wherein the third component is R-134a, provided that the composition does not comprise 86 weight % CO₂ ±1 weight %, 7 weight % R-32 ±1 weight % and 7 weight % R-134a ±1 weight %.

4. The composition according to claim 1, wherein the third component is one or more of R-1234yf or R-1234ze(E).

5. The composition according to claim 1, wherein the third component is one or more of R-1234yf, R-1234ze(E) and R-227ea.

6. The composition according to claim 1 comprising CO₂ in a range selected from about 62 or about 65 to about 98 weight % CO₂, from about 69 or about 71 to about 97 weight %, from about 74 or about 77 to about 96 weight %, from about 81 to about 96 weight %, or from about 81 or about 84 to about 95 weight %.

7. The composition according to claim 1 comprising R-32 in a range selected from about 1 to about 25 weight % R-32, from about 2 to about 22 weight %, from about 3 to about 19 weight %, from about 4 weight % to about 15 or about 13 weight %,or from about 5 weight % to about 11 weight %.

8. The composition according to claim 1 comprising the third component is in a range selected from about 1 to about 20 weight % of the third component, from about 2 or about 3 to about 15 weight %, from about 4 to about 13 weight %, or from about 5 to about 11 weight %.

9. The composition according to claim 3 comprising, from about 65 to about 95 weight % CO₂, from about 5 to about 15 weight % R-32 and from about 2 to about 20 weight % R-134a.

10. The composition according to claim 9 wherein the CO₂ is present in amount of from about 70 to about 91 weight %, the R-32 is present in an amount of from about 6 to about 14 weight % and the R-134a is present in an amount of from about 3 to about 16 weight %; or wherein the CO₂ is present in amount of from about 72 to about 88 weight %, the R-32 is present in an amount of from about 8 to about 13 weight % and the R-134a is present in an amount of from about 4 to about 15 weight %.

11. The composition according to claim 1, wherein the composition additionally comprises 1,1-difluoroethylene (R-1132a).

12. The composition according to claim 11 comprising R-1132a in a range selected from about 1 to about 20 weight % R-1132a, from about 2 to about 15 weight %, from about 3 to about 12 weight %, or from about 4 or about 5 to about 10 weight %.

13. The composition according to claim 1, wherein the composition comprises substantially no 1,1,2-trifluoroethylene (R-1123).

14. The composition according to claim 1 consisting essentially of the stated components.

15. The composition according to claim 1, wherein the composition is non-flammable as formulated, such as wherein the composition is not flammable as determined in accordance with ASHRAE Standard 34:2019.

16. The composition according to claim 1 having a Global Warming Potential (GWP) of less than about 300, less than about 240, less than about 200, less than about 160, less than about 150, or less than about 145.

17. The composition according to claim 1 having a critical temperature which is about equal to or higher than the critical temperature of CO₂, or higher than about 40° C.

18. The composition according to claim 1, wherein the composition has a volumetric refrigeration capacity that is within at least about 75% of that of CO₂, within at least about 80%, or within at least about 90%.

19. The composition according to claim 1, wherein the composition has a coefficient of performance (COP) that is about equal to or higher than that of CO₂.

20. The composition according to claim 1, wherein the composition has an operating pressure in a gas cooler or evaporator that is lower than that of CO₂.

21. The composition according to claim 1, wherein the composition has a temperature glide in an evaporator or condenser which is less than about 12 K, less than about 10 K, less than about 8 K, or less than about 6 K.

22. The composition comprising a lubricant and a composition according to claim 1, preferably wherein the lubricant is selected from mineral oil, silicon oil, polyalkyl benzenes (PABs), polyol esters (POEs), polyalkylene glycols (PAGs), polyalkylene glycol esters (PAG esters), polyvinyl ethers (PVEs), poly (alpha-olefins) and combinations thereof.

23. The composition according to claim 22, wherein the lubricant is selected from PAGs, POEs, PVEs and combinations thereof.

24. A method comprising providing the composition according to claim 1 as a working fluid in a heat transfer system, comprising a refrigeration, heat pump or air-conditioning system.

25. The method of claim 24, wherein the refrigeration system comprises a commercial refrigeration system, such as a supermarket display refrigeration system, beverage cooler refrigeration system, warehouse refrigeration system or a cold-room refrigeration system.

26. The method of claim 24, wherein the refrigeration system comprises a transportation refrigeration system, such as a refrigeration system fitted to a refrigerating shipping container or a refrigeration system fitted to a vehicle.

27. The method of claim 24, wherein the heat pump system comprises a water heater heat pump system.

28. The method of claim 24 wherein the air-conditioning system comprises a mobile or transportation air-conditioning system, such as a bus, car, train or truck air-conditioning system.

29. The method of claim 24, wherein the heat transfer system operates as a transcritical heat transfer system for at least part of the year.

30. A heat transfer device comprising a composition as defined in claim 1.

31. The heat transfer device according to claim 30, wherein the heat transfer device is a transcritical heat transfer device, comprising a transcritical refrigeration, heat pump or air-conditioning device.

32. The method according to claim 24 wherein the composition is provided as an alternative for an existing working fluid in a the heat transfer system.

33. The method according to claim 32, wherein the existing working fluid is R-410A or R-407C.

34. A method for cooling an article which comprises condensing a composition defined in claim 1 and thereafter evaporating the composition in the vicinity of the article to be cooled.

35. A method for heating an article which comprises condensing a composition as defined in -claim 1 in the vicinity of the article to be heated and thereafter evaporating the composition.
